(19) United States
(12) Patent Application Publication
(10) Pub. No.: US 2026/0245087 A1
(43) Pub. Date: Aug. 20, 2026

(54) Method, System, and Computer Program Product for Updating Encryption Keys

(71) Applicant: VISA INTERNATIONAL SERVICE ASSOCIATION, San Francisco, CA (US)

(72) Inventors: Siddhartha Chikatamalla, Mentor, OH (US); Christopher James Bohatka, Mentor, OH (US); Andrew Thomas Heiss, Mentor, OH (US); Ian Matthew Poole, Avon Lake, OH (US); Shrey Devendra Bhagat, North Royalton, OH (US); Khaing Mar Soe, Lyndhurst, OH (US)

(21) Appl. No.: 19/159,414

(22) PCT Filed: Feb. 28, 2024
(86) PCT No.: PCT/US24/17589

§ 371 Date: Aug. 25, 2025

Related U.S. Application Data
(60) Provisional application No. 63/448,889, filed on Feb. 28, 2023.

(51) Int. Cl. G06Q 20/40; H04L 9/08; H04L 9/32

(52) U.S. Cl. CPC G06Q 20/401; H04L 9/0891; H04L 9/3271

(57) ABSTRACT

Systems, methods, and computer program products are provided for updating encryption keys. An example method includes distributing an SDK including a software function to establish a secure connection between a client-side application running the SDK and a remote server computer; transmitting, to the merchant application, a key value; receiving a transaction request associated with a transaction, the transaction request initiated through the merchant application; in response to receiving the transaction request, transmitting an authentication request to the merchant application; receiving encrypted data from the merchant application, the encrypted data generated with the key value and based on device data; generating an authentication decision for the transaction based on determining that the encrypted data is valid; and updating, in the merchant application, the key value to replace the key value with updated key value.

### CROSS REFERENCE TO RELATED APPLICATIONS

This application is the United States national phase of International Application No. PCT/US24/17589, filed Feb. 28, 2024, and claims the benefit of U.S. Provisional Application No. 63/448,889, filed Feb. 28, 2023, the disclosures of which are hereby incorporated by reference in their entireties.

### BACKGROUND

### 1. Technical Field

This disclosure relates generally to managing encryption keys and, in some non-limiting embodiments or aspects, to methods, systems, and computer program products for updating encryption keys.

### 2. Technical Considerations

Payment transactions initiated with a mobile device often undergo a Three-Domain Secure (3DS) protocol as an additional layer of fraud protection. In some 3DS protocols, a challenge process is completed as a technique to ensure that the payment transaction is not fraudulent. The 3DS protocol may involve a public-private key encryption process that helps confirm the validity of the payment transaction by a merchant application encrypting certain data and an authentication server verifying the encrypted data. The key values used for the encryption process may become compromised over time, such that they require periodic update to keep the process secure. Updating key values is presently an inefficient process that requires re-coding a software development kit distributed to the merchant application. Improving the updating of the key values used in the encryption process of 3DS protocols would conserve processing resources involved with periodically updating the key values while maintaining the security of the mobile transaction.

Further, the authentication server engaging with the merchant application during the 3DS protocol to validate the payment transaction may be different from transaction to transaction based on a number of factors, such as the issuer system associated with the payment device initiating the transaction. As such, the merchant application may be configured to engage with a plurality of different authentication servers. Given the constantly changing list of trusted authentication servers and/or the network addresses (e.g., URLs) associated therewith, there is a risk of the merchant application communicating sensitive transaction data to an incorrect and/or fraudulent network address. Therefore, solutions ensuring a secure connection between the merchant application and the authentication server relevant to a particular transaction can maintain security of the 3DS protocol.

### SUMMARY

Accordingly, provided are improved systems, methods, and computer program products for updating encryption keys that overcome some or all of the deficiencies identified above.

According to non-limiting embodiments or aspects, a computer-implemented method includes: distributing a software development kit (SDK) including at least one software function to establish a secure connection between a client-side application running the SDK and a remote server computer; in response to receiving a request from a merchant application incorporating the SDK, transmitting, to the merchant application, at least one key value; receiving a transaction request associated with a transaction, the transaction request initiated through the merchant application; in response to receiving the transaction request, transmitting an authentication request to the merchant application; receiving encrypted data from the merchant application, the encrypted data generated with the at least one key value and based on device data associated with a user device initiating the transaction; generating an authentication decision for the transaction based on determining whether the encrypted data is valid; and updating, via the secure connection and in the merchant application, the at least one key value to replace the at least one key value with at least one updated key value.

In some non-limiting embodiments or aspects, the transaction request may be associated with a payment transaction between a user associated with the user device and a merchant associated with the merchant application, the user device may be a mobile device of the user.

In some non-limiting embodiments or aspects, determining whether the encrypted data is valid may include decrypting the encrypted data by applying at least one second key value and determining whether the decrypted data is valid, the at least one second key value and the at least one first key value forming a key pair.

In some non-limiting embodiments or aspects, the authentication decision may represent that the encrypted data is not valid, the computer-implemented method may further include initiating a challenge protocol in response to determining that the encrypted data is not valid, the challenge protocol may include: transmitting a public key generated by an authentication server to the merchant application, the authentication server retaining a private key, the public key and the private key forming a key pair; receiving second encrypted data from the merchant application generated with the public key and based on challenge data; transmitting a challenge request to the authentication server, the challenge request including the second encrypted data; and receiving a challenge response from the authentication server, the challenge response validating the second encrypted data based on decrypting the second encrypted data by applying the private key to the second encrypted data.

In some non-limiting embodiments or aspects, updating the at least one key value may include transmitting via the secure connection the at least one updated key value to the merchant application to cause the at least one updated key value to be cached in the merchant application.

In some non-limiting embodiments or aspects, generating the authentication decision may include: in response to receiving the encrypted data from the merchant application, determining an authentication server associated with the transaction request; generating a request including the encrypted data, and based on the determined authentication server, transmitting the request to the authentication server to cause the authentication server to determine whether the encrypted data is valid.

In some non-limiting embodiments or aspects, the at least one key value may be updated in response to receiving the transaction request.

In some non-limiting embodiments or aspects, the at least one key value and the at least one updated key value may not be hardcoded into the SDK.

In some non-limiting embodiments or aspects, updating the at least one key value may not include modifying code of the SDK.

According to non-limiting embodiments or aspects, provided is a system including at least one processor configured to: distribute a software development kit (SDK) including at least one software function to establish a secure connection between a client-side application running the SDK and a remote server computer; in response to receiving a request from a merchant application incorporating the SDK, transmit, to the merchant application, at least one key value; receive a transaction request associated with a transaction, the transaction request initiated through the merchant application; in response to receiving the transaction request, transmit an authentication request to the merchant application; receive encrypted data from the merchant application, the encrypted data generated with the at least one key value and based on device data associated with a user device initiating the transaction; generate an authentication decision for the transaction based on determining that the encrypted data is valid; and update, via the secure connection and in the merchant application, the at least one key value to replace the at least one key value with at least one updated key value.

In some non-limiting embodiments or aspects, the transaction request may be associated with a payment transaction between a user associated with the user device and a merchant associated with the merchant application; the user device may be a mobile device of the user.

In some non-limiting embodiments or aspects, determining whether the encrypted data is valid may include decrypting the encrypted data by applying at least one second key value and determining whether the decrypted data is valid, the at least one second key value and the at least one first key value forming a key pair.

In some non-limiting embodiments or aspects, the authentication decision may represent that the encrypted data is not valid, the at least one processor may be configured to initiate a challenge protocol in response to determining that the encrypted data is not valid, the challenge protocol may include: transmitting a public key generated by an authentication server to the merchant application, the authentication server retaining a private key, the public key and the private key forming a key pair; receiving second encrypted data from the merchant application generated with the public key and based on challenge data; transmitting a challenge request to the authentication server, the challenge request including the second encrypted data; and receiving a challenge response from the authentication server, the challenge response validating the second encrypted data based on decrypting the second encrypted data by applying the private key to the second encrypted data.

In some non-limiting embodiments or aspects, updating the at least one key value may include transmitting via the secure connection the at least one updated key value to the merchant application to cause the at least one updated key value to be cached in the merchant application.

In some non-limiting embodiments or aspects, generating the authentication decision may include: in response to receiving the encrypted data from the merchant application, determining an authentication server associated with the transaction request; generating a request including the encrypted data, and based on the determined authentication server, transmitting the request to the authentication server to cause the authentication server to determine whether the encrypted data is valid.

In some non-limiting embodiments or aspects, the at least one key value may be updated in response to receiving the transaction request.

In some non-limiting embodiments or aspects, the at least one key value and the at least one updated key value may not be hardcoded into the SDK.

In some non-limiting embodiments or aspects, updating the at least one key value may not include modifying code of the SDK.

According to non-limiting embodiments or aspects, provided is a computer program product including at least one non-transitory computer-readable medium including program instructions that, when executed by at least one processor, cause the at least one processor to: distribute a software development kit (SDK) including at least one software function to establish a secure connection between a client-side application running the SDK and a remote server computer; in response to receiving a request from a merchant application incorporating the SDK, transmit, to the merchant application, at least one key value; receive a transaction request associated with a transaction, the transaction request initiated through the merchant application; in response to receiving the transaction request, transmit an authentication request to the merchant application; receive encrypted data from the merchant application, the encrypted data generated with the at least one key value and based on device data associated with a user device initiating the transaction; generate an authentication decision for the transaction based on determining whether the encrypted data is valid; and update, via the secure connection and in the merchant application, the at least one key value to replace the at least one key value with at least one updated key value.

In some non-limiting embodiments or aspects, the transaction request may be associated with a payment transaction between a user associated with the user device and a merchant associated with the merchant application, the user device may be a mobile device of the user.

In some non-limiting embodiments or aspects, determining whether the encrypted data is valid may include decrypting the encrypted data by applying at least one second key value and determining whether the decrypted data is valid, the at least one second key value and the at least one first key value forming a key pair.

In some non-limiting embodiments or aspects, the authentication decision may represent that the encrypted data is not valid, the program instructions may cause initiating a challenge protocol in response to determining that the encrypted data is not valid, the challenge protocol may include: transmitting a public key generated by an authentication server to the merchant application, the authentication server retaining a private key, the public key and the private key forming a key pair; receiving second encrypted data from the merchant application generated with the public key and based on challenge data; transmitting a challenge request to the authentication server, the challenge request including the second encrypted data; and receiving a challenge response from the authentication server, the challenge response validating the second encrypted data based on decrypting the second encrypted data by applying the private key to the second encrypted data.

In some non-limiting embodiments or aspects, updating the at least one key value may include transmitting via the secure connection the at least one updated key value to the merchant application to cause the at least one updated key value to be cached in the merchant application.

In some non-limiting embodiments or aspects, generating the authentication decision may include: in response to receiving the encrypted data from the merchant application, determining an authentication server associated with the transaction request; generating a request including the encrypted data, and based on the determined authentication server, transmitting the request to the authentication server to cause the authentication server to determine whether the encrypted data is valid.

In some non-limiting embodiments or aspects, the at least one key value may be updated in response to receiving the transaction request.

In some non-limiting embodiments or aspects, the at least one key value and the at least one updated key value may not be hardcoded into the SDK.

In some non-limiting embodiments or aspects, updating the at least one key value may not include modifying code of the SDK.

Further non-limiting embodiments or aspects are set forth in the following numbered clauses:

Clause 1: A computer-implemented method comprising: distributing a software development kit (SDK) including at least one software function to establish a secure connection between a client-side application running the SDK and a remote server computer; in response to receiving a request from a merchant application incorporating the SDK, transmitting, to the merchant application, at least one key value; receiving a transaction request associated with a transaction, the transaction request initiated through the merchant application; in response to receiving the transaction request, transmitting an authentication request to the merchant application; receiving encrypted data from the merchant application, the encrypted data generated with the at least one key value and based on device data associated with a user device initiating the transaction; generating an authentication decision for the transaction based on determining whether the encrypted data is valid; and updating, via the secure connection and in the merchant application, the at least one key value to replace the at least one key value with at least one updated key value.

Clause 2: The computer-implemented method of clause 1, wherein the transaction request is associated with a payment transaction between a user associated with the user device and a merchant associated with the merchant application, the user device being a mobile device of the user.

Clause 3: The computer-implemented method of clause 1 or 2, wherein determining whether the encrypted data is valid comprises decrypting the encrypted data by applying at least one second key value and determining whether the decrypted data is valid, the at least one second key value and the at least one first key value forming a key pair.

Clause 4: The computer-implemented method of any of clauses 1-3, wherein the authentication decision represents that the encrypted data is not valid, the computer-implemented method further comprising initiating a challenge protocol in response to determining that the encrypted data is not valid, the challenge protocol comprising: transmitting a public key generated by an authentication server to the merchant application, the authentication server retaining a private key, the public key and the private key forming a key pair; receiving second encrypted data from the merchant application generated with the public key and based on challenge data; transmitting a challenge request to the authentication server, the challenge request comprising the second encrypted data; and receiving a challenge response from the authentication server, the challenge response validating the second encrypted data based on decrypting the second encrypted data by applying the private key to the second encrypted data.

Clause 5: The computer-implemented method of any of clauses 1-4, wherein updating the at least one key value comprises transmitting via the secure connection the at least one updated key value to the merchant application to cause the at least one updated key value to be cached in the merchant application.

Clause 6: The computer-implemented method of any of clauses 1-5, wherein generating the authentication decision comprises: in response to receiving the encrypted data from the merchant application, determining an authentication server associated with the transaction request; generating a request comprising the encrypted data, and based on the determined authentication server, transmitting the request to the authentication server to cause the authentication server to determine whether the encrypted data is valid.

Clause 7: The computer-implemented method of any of clauses 1-6, wherein the at least one key value is updated in response to receiving the transaction request.

Clause 8: The computer-implemented method of any of clauses 1-7, wherein the at least one key value and the at least one updated key value are not hardcoded into the SDK.

Clause 9: The computer-implemented method of any of clauses 1-8, wherein updating the at least one key value does not comprise modifying code of the SDK.

Clause 10: A system comprising at least one processor configured to: distribute a software development kit (SDK) including at least one software function to establish a secure connection between a client-side application running the SDK and a remote server computer; in response to receiving a request from a merchant application incorporating the SDK, transmit, to the merchant application, at least one key value; receive a transaction request associated with a transaction, the transaction request initiated through the merchant application; in response to receiving the transaction request, transmit an authentication request to the merchant application; receive encrypted data from the merchant application, the encrypted data generated with the at least one key value and based on device data associated with a user device initiating the transaction; generate an authentication decision for the transaction based on determining that the encrypted data is valid; and update, via the secure connection and in the merchant application, the at least one key value to replace the at least one key value with at least one updated key value.

Clause 11: The system of clause 10, wherein the transaction request is associated with a payment transaction between a user associated with the user device and a merchant associated with the merchant application, the user device being a mobile device of the user.

Clause 12: The system of clause 10 or 11, wherein determining whether the encrypted data is valid comprises decrypting the encrypted data by applying at least one second key value and determining whether the decrypted data is valid, the at least one second key value and the at least one first key value forming a key pair.

Clause 13: The system of any of clauses 10-12, wherein the authentication decision represents that the encrypted data is not valid, the at least one processor configured to initiate a challenge protocol in response to determining that the encrypted data is not valid, the challenge protocol comprising: transmitting a public key generated by an authentication server to the merchant application, the authentication server retaining a private key, the public key and the private key forming a key pair; receiving second encrypted data from the merchant application generated with the public key and based on challenge data; transmitting a challenge request to the authentication server, the challenge request comprising the second encrypted data; and receiving a challenge response from the authentication server, the challenge response validating the second encrypted data based on decrypting the second encrypted data by applying the private key to the second encrypted data.

Clause 14: The system of any of clauses 10-13, wherein updating the at least one key value comprises transmitting via the secure connection the at least one updated key value to the merchant application to cause the at least one updated key value to be cached in the merchant application.

Clause 15: The system of any of clauses 10-14, wherein generating the authentication decision comprises: in response to receiving the encrypted data from the merchant application, determining an authentication server associated with the transaction request; generating a request comprising the encrypted data, and based on the determined authentication server, transmitting the request to the authentication server to cause the authentication server to determine whether the encrypted data is valid.

Clause 16: The system of any of clauses 10-15, wherein the at least one key value is updated in response to receiving the transaction request.

Clause 17: The system of any of clauses 10-16, wherein the at least one key value and the at least one updated key value are not hardcoded into the SDK.

Clause 18: The system of any of clauses 10-17, wherein updating the at least one key value does not comprise modifying code of the SDK.

Clause 19: A computer program product comprising at least one non-transitory computer-readable medium including program instructions that, when executed by at least one processor, cause the at least one processor to: distribute a software development kit (SDK) including at least one software function to establish a secure connection between a client-side application running the SDK and a remote server computer; in response to receiving a request from a merchant application incorporating the SDK, transmit, to the merchant application, at least one key value; receive a transaction request associated with a transaction, the transaction request initiated through the merchant application; in response to receiving the transaction request, transmit an authentication request to the merchant application; receive encrypted data from the merchant application, the encrypted data generated with the at least one key value and based on device data associated with a user device initiating the transaction; generate an authentication decision for the transaction based on determining whether the encrypted data is valid; and update, via the secure connection and in the merchant application, the at least one key value to replace the at least one key value with at least one updated key value.

Clause 20: The computer program product of clause 19, wherein the transaction request is associated with a payment transaction between a user associated with the user device and a merchant associated with the merchant application, the user device being a mobile device of the user.

Clause 21: The computer program product of clause 19 or 20, wherein determining whether the encrypted data is valid comprises decrypting the encrypted data by applying at least one second key value and determining whether the decrypted data is valid, the at least one second key value and the at least one first key value forming a key pair.

Clause 22: The computer program product of any of clauses 19-21, wherein the authentication decision represents that the encrypted data is not valid, the program instructions cause initiating a challenge protocol in response to determining that the encrypted data is not valid, the challenge protocol comprising: transmitting a public key generated by an authentication server to the merchant application, the authentication server retaining a private key, the public key and the private key forming a key pair; receiving second encrypted data from the merchant application generated with the public key and based on challenge data; transmitting a challenge request to the authentication server, the challenge request comprising the second encrypted data; and receiving a challenge response from the authentication server, the challenge response validating the second encrypted data based on decrypting the second encrypted data by applying the private key to the second encrypted data.

Clause 23: The computer program product of any of clauses 19-22, wherein updating the at least one key value comprises transmitting via the secure connection the at least one updated key value to the merchant application to cause the at least one updated key value to be cached in the merchant application.

Clause 24: The computer program product of any of clauses 19-23, wherein generating the authentication decision comprises: in response to receiving the encrypted data from the merchant application, determining an authentication server associated with the transaction request; generating a request comprising the encrypted data, and based on the determined authentication server, transmitting the request to the authentication server to cause the authentication server to determine whether the encrypted data is valid.

Clause 25: The computer program product of any of clauses 19-24, wherein the at least one key value is updated in response to receiving the transaction request.

Clause 26: The computer program product of any of clauses 19-25, wherein the at least one key value and the at least one updated key value are not hardcoded into the SDK.

Clause 27: The computer program product of any of clauses 19-26, wherein updating the at least one key value does not comprise modifying code of the SDK.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of an example system for updating encryption keys, according to some non-limiting embodiments or aspects;

FIGS. 2-3 are process flow diagrams of example systems for processing payment transactions using an authentication and/or challenge protocol, according to some non-limiting embodiments or aspects;

FIG. 4 is a process flow diagram of an example system for processing payment transactions using a challenge protocol, according to some non-limiting embodiments or aspects;

FIG. 5 is a process flow diagram of an example system for encrypting device data during an authentication protocol, according to some non-limiting embodiments or aspects;

FIG. 6 is a process flow diagram of an example system for updating encryption keys, according to some non-limiting embodiments or aspects;

FIG. 7 is a flow diagram of a process for updating encryption keys, according to some non-limiting embodiments or aspects;

FIG. 8 is a diagram of an example environment of an electronic payment processing network in which methods, systems, and/or computer program products, described herein, may be implemented according to some non-limiting embodiments or aspects; and

FIG. 9 is a schematic diagram of example components of one or more devices of FIGS. 1-6 and FIG. 8 according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of payment devices managed by a transaction service provider. As used herein, the term “payment gateway system” may refer to one or more computer systems, computer devices, servers, groups of servers, and/or the like, operated by or on behalf of a payment gateway.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for updating encryption keys. For example, non-limiting embodiments or aspects may include distributing a software development kit (SDK) to a merchant application, which may comprise at least one software function to establish a secure connection between a client-side application running the SDK and a remote server computer and which may be invoked during a 3DS protocol. The merchant application may receive and cache a key value, which may be used to encrypt challenge data during the 3DS protocol to authenticate the transaction. The key value may not be hardcoded into the SDK to reduce processing resources required to periodically update the key value. Non-limiting embodiments or aspects may automatically update the key value to replace the key value with an updated key value. The updated key value may be cached by the merchant application and may be used to encrypt device data during an authentication process of the 3DS protocol to authenticate transactions. The updated key value may not be hardcoded into the SDK and may be updated without modifying the code of the merchant application and/or SDK to reduce processing resources required to periodically update the key value. For example, an SDK does not need to be redistributed and incorporated into the merchant application to update a key value. As such, the key values are stored remotely from the SDK such that the key values can be efficiently updated by caching an updated key value without redistributing the SDK and recompiling the merchant application with a new SDK for every update to the key value.

Non-limiting embodiments or aspects involve generating an authentication request to validate a mobile transaction. The authentication request may comprise encrypting data generated by the merchant application applying a first key to the device data (e.g. of a user device of a user initiating the transaction) to form first encrypted data. An authentication server may receive the authentication request comprising the first encrypted data from the merchant application. The authentication server may decrypt the first encrypted data with a second key different from the first key (but forming a key pair therewith) to determine whether the first encrypted data is valid, and whether the transaction should be authenticated. Use of the encryption keys by the merchant application and the authentication server allows the transaction to be securely validated, thus reducing the risk of fraud associated with mobile transactions, which historically have fraud rates higher than, for example, card present transactions in which the payment device is present at the merchant point-of-sale. Should the authentication request determine that the encrypted data is not valid, a challenge protocol involving encrypting and decrypting challenge data with keys (e.g., a separate set of keys) exchanged by the merchant application and the authentication server may be initiated to determine whether the transaction should proceed.

Non-limiting embodiments or aspects ensure a secure connection between the merchant application and the relevant authentication server for the transaction using an authentication interface. The authentication interface may determine the authentication server associated with the transaction to link the merchant application with the correct authentication server. Including the authentication interface in the 3DS process may improve security of the 3DS process by ensuring that the authentication request and/or challenge request are routed to the correct network address and reduce the processing resources previously required by the merchant application to track trusted authentication server network addresses.

For the purpose of illustration, in the following description, while the presently disclosed subject matter is described with respect to systems, methods, and computer program products for updating encryption keys, one skilled in the art will recognize that the disclosed subject matter is not limited to the illustrative embodiments.

A “key” may refer to a piece of information that is used in a cryptographic algorithm to transform input data into another representation. A cryptographic algorithm can be an encryption algorithm that transforms original data into an alternate representation, or a decryption algorithm that transforms encrypted information back to the original data. Symmetric and/or asymmetric encryption may be used.

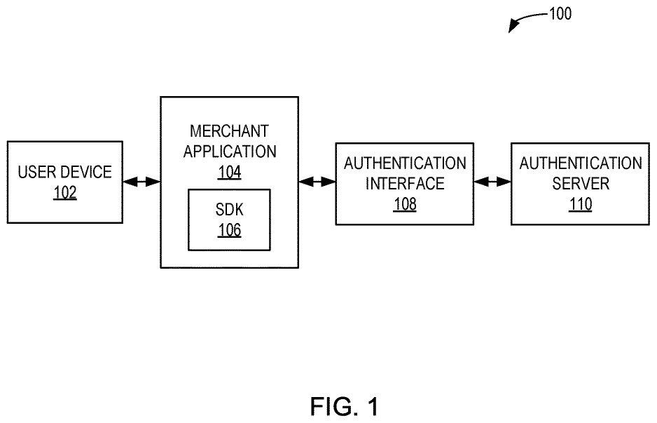

FIG. 1 depicts an example system 100 for updating encryption keys according to some non-limiting embodiments or aspects. The system 100 may include a user device 102, a merchant application 104 comprising an SDK 106 (e.g., a merchant application compiled using an SDK), an authentication interface 108, and an authentication server 110.

User device 102 may include at least one computing device, as described herein. For example, user device 102 may include a computer (e.g., portable computer, non-mobile computer, and/or the like), a server (e.g., a single server), a group of servers, and/or other like devices of a user. In some non-limiting embodiments or aspects, user device 102 may include at least one processor (e.g., a multi-core processor) such as a graphics processing unit (GPU), a central processing unit (CPU), an accelerated processing unit (APU), a microprocessor, and/or the like. In some non-limiting embodiments or aspects, user device 102 may include memory, one or more storage components, one or more input components, one or more output components, and/or one or more communication interfaces, as described herein. In some non-limiting embodiments or aspects, user device 102 may be in communication with merchant application 104, e.g., to initiate an electronic payment transaction.

Merchant application 104 may include at least one processor (e.g., a multi-core processor) such as a graphics processing unit (GPU), a central processing unit (CPU), an accelerated processing unit (APU), a microprocessor, and/or the like. The merchant application 104 may incorporate SDK 106 (e.g., may be compiled based on the SDK) which may include at least one software function to establish a secure connection between a client-side application running SDK 106 and a remote server computer. Merchant application 104 may be capable of encrypting data by applying a key value to device data during an authentication request or challenge data during a challenge request (said keys may be the same or different for authentication and challenging). Merchant application 104 may be in communication with user device 102 and/or authentication interface 108 and/or authentication server 110, as described herein.

Authentication interface 108 may include at least one processor (e.g., a multi-core processor) such as a graphics processing unit (GPU), a central processing unit (CPU), an accelerated processing unit (APU), a microprocessor, and/or the like. The authentication interface 108 may function as an intermediary between the relevant merchant application 104 and the authentication server 110 for the transaction to secure a connection therebetween to facilitate the authentication process. The authentication interface 108 may distribute SDK 106 to the merchant application 104 and may periodically update key values cached in merchant application 104. The authentication interface 108 may be in communication with merchant application 104 and/or authentication server 110, as described herein. The authentication interface 108 may be in communication with a plurality of different merchant applications 104 and/or a plurality of different authentication servers 110, so as to be capable of communicating with the merchant application 104 and/or the authentication server 110 relevant to the transaction being processed.

Authentication server 110 may include at least one processor (e.g., a multi-core processor) such as a graphics processing unit (GPU), a central processing unit (CPU), an accelerated processing unit (APU), a microprocessor, and/or the like. The authentication server 110 may be capable of decrypting data by applying a key value to encrypted data from the merchant application 104 (e.g., encrypted device and/or challenge data) in order to authenticate encrypted data as valid during an authentication process and/or a challenge process. The authentication server 110 may be in communication with authentication interface 108 and/or merchant application 104.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

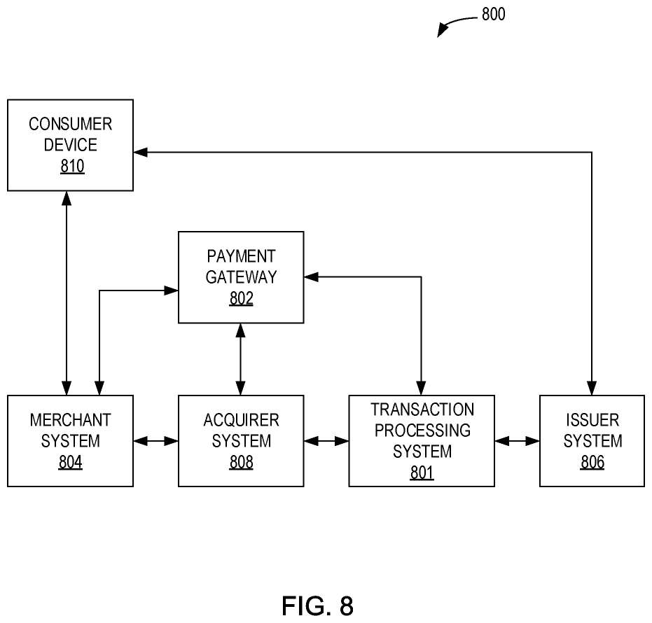

With continued reference to FIG. 1, in some non-limiting embodiments or aspects, authentication interface 108 may generate (e.g., hardcode) SDK 106 that includes at least one software function to establish a secure connection between a client-side application (e.g., merchant application 104) and a remote server computer (e.g., authentication interface 108 and/or authentication server 110). The SDK 106 may be distributed by authentication interface 108 to a merchant system and/or a system associated therewith that enables the merchant application 104 to be compiled with the SDK 106. The merchant system may publish the merchant application 104, such as enabling the merchant application 104 to be downloaded on and/or engage with one or more computing device (e.g., user device 102). The merchant application 104 compiled from the received SDK 106 may be configured to establish a secure connection with authentication interface 108 and/or authentication server 110. The merchant application 104 may establish a secure connection with authentication interface 108 and/or authentication server 110 in order to process electronic payment transactions over an electronic payment processing network (see e.g., FIG. 8).

With continued reference to FIG. 1, in response to receiving a request from the merchant application 104 incorporating the SDK 106, the authentication interface 108 may transmit at least one key value to the merchant application 104. The key value may not be incorporated (e.g., hardcoded) into the SDK 106. The key value may have been generated by the authentication server 110. The key value may have been generated by the authentication interface 108.

The at least one key value may be used to encrypt data, such by applying the key value to the unencrypted data to generate encrypted data. The merchant application 104 may cache the key value received from the authentication interface 108. Caching the key value may comprise storing the key value in a cache memory, which may be an auxiliary memory storage device from which high speed retrieval is possible. Data stored in the cache memory may be retrieved with higher speed compared to data stored in one or more separate data storage devices of the merchant application 104.

With continued reference to FIG. 1, in some non-limiting embodiments or aspects, the system 100 may be used to authenticate an electronic payment transaction, such as an electronic payment transaction processed over an electronic payment processing network (see e.g., FIG. 8). The electronic payment transaction may be a payment transaction between the merchant of the merchant application 104 and the user of the user device 102. The user may use a payment device to initiate the payment transaction, and the user device 102 may engage with the merchant application 104 to initiate and/or process the payment transaction.

During the payment transaction, the merchant application 104 may generate a transaction request to cause the system 100 to authenticate the payment transaction. The merchant application 104 may transmit the transaction request to the authentication interface 108 to initiate authentication of the payment transaction.

In response to receiving the transaction request, the authentication interface 108 may generate an authentication request and transmit the authentication request to the merchant application 104.

In some non-limiting embodiments or aspects, the merchant application 104 may collect device data associated with the user device 102 (e.g., a mobile device). The device data may have been previously transmitted to and/or stored by the authentication interface 108 and/or the authentication server 110 (e.g., during a previous transaction of the user, and onboarding procedure for the user, or the like). Device data may comprise any data associated with the user device 102 that may either uniquely identify the user device 102 or contribute to identifying at least one characteristic of the user device 102. Non-limiting examples of device data may include a unique device identifier, a device type, a network address (e.g., IP address), device geolocation data, device browser data, and the like. Non-limiting examples of device browser data may include a browser accept header, data indicating whether the browser is Java-enabled, browser language (e.g., language in which browser displays the data to the user via the user interface), browser color depth (e.g., bit depth of the color palette for displaying images), browser screen depth (e.g., bit depth of the screen), browser screen height, browser screen width, browser time zone (e.g., time zone associated with the browser), browser user agent (e.g., the software agent acting on behalf of the user), or other data associated with the browser of the user device 102.

The merchant application 104 may encrypt the unencrypted device data. The device data may be encrypted by the merchant application 104 applying the cached key value to the device data to generate encrypted data. Thus, the encrypted data may be based on the key value and the unencrypted device data. The merchant application 104 may generate an authentication response including the encrypted data and transmit the authentication response to the authentication interface 108 and/or the authentication server 110.

With continued reference to FIG. 1, in some non-limiting embodiments or aspects, the system 100 may generate an authentication decision for the payment transaction based on determining whether the encrypted data is valid. The authentication interface 108 and/or the authentication server 110 may generate the authentication decision for the payment transaction. Determining whether the encrypted data is valid may be performed based on whether the key value applied by the merchant application 104 to the unencrypted device data is valid (e.g., the current version of the key value). This may include the authentication interface 108 and/or the authentication server 110 applying at least one second key value to decrypt the encrypted data, where the first and second key values form a key pair. In some non-limiting embodiments or aspects, asymmetric encryption is used. In some non-limiting embodiments or aspects, the first key value is a public key distributed to merchant applications, and the second key value is a private key retained by authentication servers. Based on the authentication interface 108 and/or the authentication server 110 applying at least one second key value to decrypt the encrypted data, it may be determined whether the decrypted data is valid, such as by the decrypted data matching the device data or having an expected value.

The decrypted data being determined to be valid may mean that the transaction is authenticated and can continue being processed, such as by authorizing, clearing, and/or settling the payment transaction. The decrypted data being determined to be valid may mean that the user initiated the transaction using a user device 102 familiar to authentication interface 108 and/or the authentication server 110, such as a user device 102 previously associated with a user and/or by a user device 102 frequently (e.g., above a first threshold frequency) used by the user to initiate transactions.

The decrypted data being determined to be invalid may mean that the transaction is not authenticated and cannot immediately continue being processed without first undergoing at least a challenge protocol as described herein. The decrypted data being determined to be invalid may mean that the user initiated the transaction using a user device 102 unfamiliar to authentication interface 108 and/or the authentication server 110, such as a user device 102 not previously associated with a user and/or by a user device 102 not frequently (e.g., below the first threshold frequency) used by the user to initiate transactions.

In some non-limiting embodiments, or aspects, the authentication server 110 may authenticate the payment transaction as described above. In response to receiving the authentication response, the authentication interface 108 may determine the authentication server 110 associated with the transaction request. The authentication server 110 may be one authentication server among a plurality of authentication servers, and the authentication interface 108 may be in communication with the plurality of authentication servers and identify and communicate with the authentication server 110 associated with the transaction request (e.g., by retrieving and communicating with the network address of the authentication server 110). The authentication server 110 may be associated with a user, a payment device of the user, a user device of the user, a merchant system, and/or the like, making it the authentication server 110 associated with the payment transaction. Therefore, data in the transaction request may include data identifying at least one of the user, the payment device of the user, the user device 102 of the user, the merchant system (of the merchant application 104), and/or the like, which data may be used by the authentication interface 108 to match the authentication server 110 to the transaction request. A database (not shown) may associate (e.g., store an association between) at least one of the user, the payment device of the user, the user device 102 of the user, the merchant system (of the merchant application 104), and/or the like with a corresponding authentication server of the plurality of authentication servers. The authentication interface 108 may query the database based on the data contained in the transaction request to determine the authentication server 110 as associated with the transaction request and retrieve the corresponding network address.

In response to determining the authentication server 110, the authentication interface 108 may generate a request comprising the encrypted data (e.g., encrypted device data) from the authentication response. The authentication server 110 may generate an authentication decision authenticating or declining to authenticate the payment transaction as previously described based on decrypting the encrypted device data from the request using the second key value of the key pair. The authentication server 110 may return the authentication decision.

As previously mentioned, in response to the decrypted data being determined to be not valid, a challenge protocol may automatically be initiated. The authentication interface 108 may notify the merchant application of initiation of the challenge protocol.

In response to initiating the challenge protocol, the authentication interface 108 may transmit a public key generated by the authentication server 110 to the merchant application. The authentication server 110 may retain a private key generated thereby, the public key and private key forming a key pair. This public key and private key may be different from the previously described first and second key values (e.g., a different key pair for the challenge protocol compared to the authentication process). The public key and private key may be generated specific for an individual transaction (e.g., be an ephemeral key pair), such that each individual transaction undergoing a challenge process may utilize a different set of challenge keys.

In some non-limiting embodiments or aspects, the merchant application 104 may also generate a key pair (a second public key and second private key) to be used for the instant transaction. The merchant application 104 may transmit the second public key to the authentication server 110 for storage and may retain the second private key. In this way, the merchant application 104 and the authentication server 110 may exchange public keys and retain private keys to enable encrypted communication therebetween associated with the payment transaction. In some non-limiting examples, the merchant application 104 and the authentication server 110 may exchange and apply keys according to a Diffie-Hellman key exchange protocol.

With continued reference to FIG. 1, during the challenge protocol, the merchant application 104 may generate second encrypted data based on the public key and challenge data. The merchant application 104 may apply the public key to the challenge data to generate the second encrypted data. The challenge data may comprise transaction data associated with the payment transaction. Non-limiting examples of transaction data include any data used by the electronic payment processing network (see e.g., FIG. 8) to authorize, clear, and/or settle the payment transaction, such as the data elements specified in the ISO 8583. The challenge protocol may determine the predetermined type of transaction data to be used (e.g., encrypted/decrypted) during the challenge protocol. The merchant application 104 may transmit the second encrypted data to the authentication interface 108.

In response to receiving the second encrypted data, the authentication interface 108 may automatically generate a challenge request comprising the second encrypted data and may transmit the challenge request to the authentication server 110 associated with the transaction.

In response to receiving the challenge request, the authentication server 110 may determine whether the second encrypted data is valid. Determining whether the second encrypted data is valid may be performed based on whether the public key applied by the merchant application 104 to the unencrypted challenge (e.g., transaction) data is valid (e.g., the correct public key in the key exchange was applied). This may include the authentication server 110 applying the private key to decrypt the second encrypted data, since the public key and private key constitute a corresponding key pair. In some non-limiting embodiments or aspects, asymmetric encryption is used. Based on the authentication server 110 applying the private key to decrypt the second encrypted data, it may be determined whether the decrypted data is valid, such as by the decrypted data matching the challenge data or having an expected value.

The decrypted data being determined to be valid may mean that the challenge was satisfied such that the transaction can continue being processed, such as by authorizing, clearing, and/or settling the payment transaction. The decrypted data being determined to be valid may mean that the merchant application 104 encrypting the challenge data possessed and/or applied the correct public key to the correct challenge data associated with the transaction.

The decrypted data being determined to be invalid may mean that the challenge was not satisfied such that the transaction is to be terminated and/or another set of security protocols executed. The decrypted data being determined to be invalid may mean that the merchant application 104 encrypting the challenge data possessed and/or applied the incorrect public key to the challenge data and/or applied the correct public key to incorrect challenge data associated with the transaction.

With continued reference to FIG. 1, in some non-limiting embodiments or aspects, the key value cached with the merchant application 104 may be updated with an updated key value, the updated key value cached with the merchant application 104. The key value may be updated periodically (e.g., daily, weekly, monthly, and the like). The key value may be updated in response to the merchant application 104 requesting a new key value (e.g., a key update request). The key value may be updated in response to a determination (e.g., by the merchant application 104, the authentication interface 108, the authentication server 110, and the like) that the present key value cached at the merchant application 104 may have been compromised. Updating of the key value with the merchant application 104 may enhance security of transactions conducted over the electronic payment processing network.

In some non-limiting embodiments or aspects, the key value may be updated in response to the authentication interface 108 receiving the transaction request to ensure that each transaction applies the most updated key values. This process may involve updating the current key value with an updated key value if the merchant application 104 does not have the current key value cached and/or determining that no update is needed because the merchant application 104 has the current key value already cached.

The authentication interface 108 may transmit the updated key value to the merchant application 104 via the secure connection. The merchant application 104 may cache the updated key value. This may include replacing the existing key value with the updated key value in cache memory. The existing key value and the updated key value may not have been incorporated (e.g., hardcoded) into the SDK 106. Thus, updating the key value may not comprise modifying code of SDK 106. The updated key value not hardcoded into the SDK 106 may be updated without modifying the code of the merchant application 104 and/or SDK 106 and may advantageously reduce processing resources expended to periodically update the key value. For example, the SDK 106 may not need to be redistributed and incorporated into the merchant application 104 to update a key value. As such, the key values may be stored remotely from the SDK 106 such that the SDK 106 can be efficiently updated to cache an updated key value without redistributing the SDK 106 and recompiling the merchant application 104 with a new SDK 106 for every update to the key value.

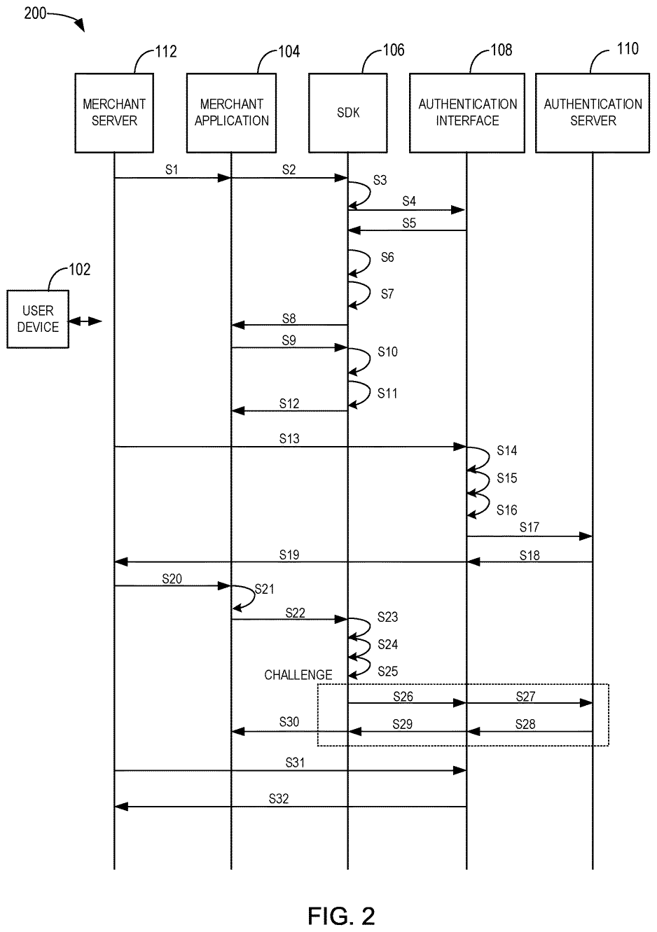

FIG. 2 shows a process 200 for processing payment transactions using an authentication and/or challenge protocol, according to some non-limiting embodiments or aspects. At a step S1, a merchant server 112 of a merchant engaging in an electronic payment transaction with a user of user device 102 may generate a token (e.g., a JSON web token), which may be transmitted to the merchant application 104. The merchant application 104 may be configured to initiate electronic payment transactions via the user device 102. At a step S2, the merchant application 104 may initialize an authentication protocol, which may be authenticated based on application context (e.g., Android), the web token, configuration or callback parameters, and the like. The SDK 106 (e.g., merchant application compiled using an SDK) may validate the web token at a step S3. In response to the web token being authenticated, the SDK 106 may, at step S4, generate and transmit to the authentication interface 108 a transaction request associated with the payment transaction between the user device 102 and the merchant application 104.

At a step S5, in response to receiving the transaction request, authentication interface 108 may determine whether SDK 106 has cached the most recent version of a first key used for authentication of payment transactions. The first key may be a public key of authentication server 110 which may store a corresponding private key used for authentication of payment transactions. In response to determining that SDK 106 does not have the most recent version of the first key, the authentication interface 108 may transmit the updated version of the first key. At a step S6, the SDK 106 may cache the first key in the merchant application 104 (e.g., without re-hardcoding the SDK 106).

With continued reference to FIG. 2, at a step S7, the SDK 106 may collect device data from the user device 102. This device data may have been previously transmitted to the authentication interface 108 and/or authentication server 110 (e.g., during previous transactions of the user). At a step S8, the merchant application 104 may determine whether the device data was successfully collected or not. At a step S9, the merchant application 104 and/or the SDK 106 may initiate a lookup digest to determine the issuer system and/or transaction processing system associated with the payment transaction, which may be determined based on the payment device used to initiate the payment transaction. At a step S10, the SDK 106 may determine the parameters to be used during the authentication process to authenticate the transaction, which may be predetermined parameters specified by the authentication server 110 as the parameters it will use to authenticate the transaction. The predetermined parameters may be a specific device data. At a step S11, the SDK 106 may encrypt the predetermined device data to be used in the authentication process with the first key cached thereon, thus generating first encrypted data. At a step S12, the SDK 106 may transmit the first encrypted data to the merchant application 104.

At a step S13, the merchant server 112 may transmit the first encrypted data to the authentication interface 108. At a step S14, the authentication interface 108 may determine the encryption key used by the SDK 106, and at a step S15 the authentication interface 108 may decrypt the first encrypted data (e.g., using the first private key of the authentication server 110). It will be appreciated that while the present flow describes the authentication interface 108 decrypting the first encrypted data, in some non-limiting embodiments or aspects, the authentication interface 108 may transmit the first encrypted data to the authentication server 110 which may decrypt the first encrypted data. At a step S16, the authentication interface 108 may generate an authentication request containing the decrypted data (e.g., the device data) or the first encrypted data to be decrypted.

At a step S17, the authentication interface 108 may transmit the authentication request to the authentication server 110 associated with the payment transaction. At a step S18, the authentication server 110 may generate an authentication decision based on the decrypted data. For example, the authentication server 110 may generate an authentication decision that the payment transaction is not authenticated based on the device data, such as by the decrypted device data not matching device data of the user stored by the authentication server 110 in association with the user. The authentication server 110 may generate and transmit an authentication response containing the authentication decision to authentication interface 108. At steps S17-S18, in some non-limiting embodiments or aspects, the authentication server 110 and the SDK 106 may exchange second keys to be used during a challenge protocol via the authentication interface 108. For example, the second keys exchanged in this step may follow a Diffie-Hellman key exchange protocol. The SDK 106 may provide the authentication server 110 its merchant public key and retain its merchant private key, and the authentication server 110 may provide the SDK 106 its ACS public key and retain its ACS private key. These second keys exchanged may be ephemeral keys only used for the instant payment transaction during a challenge protocol described hereinafter.

At a step S19, the authentication interface 108 may transmit the authentication decision to the merchant server 112. In some non-limiting embodiments or aspects, the message containing the authentication decision may comprise encrypted data (e.g., a digital signature) associated with the authentication server 110.

With continued reference to FIG. 2, at a step S20, the merchant server 112 may initiate a challenge protocol in response to determining that the authentication decision failed to authenticate the payment transaction based on the device data. At a step S21, the merchant application 104 may parse the message containing the authentication decision and determine the message version. At a step S22, the merchant application 104 may collect data needed to execute the challenge protocol. For example, the data collected to execute the challenge protocol may include the encrypted data (e.g., a digital signature) associated with the authentication server 110, transaction data (e.g., transaction identifier, and the like), and the like. At a step S23, the SDK 106 may validate the encrypted data associated with the authentication server 110. This data may be validated by applying a third public key (e.g., different from the first key) to the encrypted data to validate that the authentication decision came from the authentication server 110. The encrypted data may have been encrypted by the authentication server 110 using the corresponding third private key, the third public key and third private key forming a key pair. This set of third keys may be updated in the same manner as the first keys (as described throughout the present application).

At a step S24, the SDK 106 may retrieve the key to be used for the challenge protocol (e.g., the second keys). At a step S25, the SDK 106 may encrypt challenge data. The challenge data may comprise transaction data associated with the payment transaction. The SDK 106 may encrypt the challenge data by applying the ACS public key to the challenge data to form second encrypted data. Alternatively, the SDK 106 may encrypt the challenge data by applying the merchant private key to the challenge data to enable validation by the authentication server 110 using the merchant public key.

At a step S26, the second encrypted data may be transmitted from the SDK 106 to the authentication interface 108. At a step S27, the authentication interface 108 may generate a challenge request containing the second encrypted data, and the challenge request may be transmitted to the authentication server 110. At a step S28, in response to receiving the challenge request, the authentication server 110 may decrypt the second encrypted data. The second encrypted data may be decrypted by applying the ACS private key to the second encrypted data (e.g., to generate the original challenge data). The authentication server 110 may generate a challenge decision indicating whether the challenge was validated or not, such as by determining whether the decrypted challenge data matches an expected value (e.g., the accurate value for the transaction data encrypted during the challenge). The authentication server 110 may generate a challenge response containing the challenge decision. At a step S29, the authentication interface 108 may transmit the challenge decision to the SDK 106.

With continued reference to FIG. 2, at a step S30, the merchant application 104 may receive the challenge decision along with the transaction status and the transaction identifier. At a step S31, the merchant server 112 may authenticate that the challenge decision came from the authentication server 110 (e.g. using the third keys as previously described). At a step S32, the authentication interface 108 may transmit an electronic commerce indicator (ECI) and/or a CAVV result code to provide the merchant server 112 with the outcome of the authentication (e.g., the authentication protocol and/or challenge protocol), which may be used to determine whether processing (e.g., authorization clearing, settling) of the payment transaction should be continued.

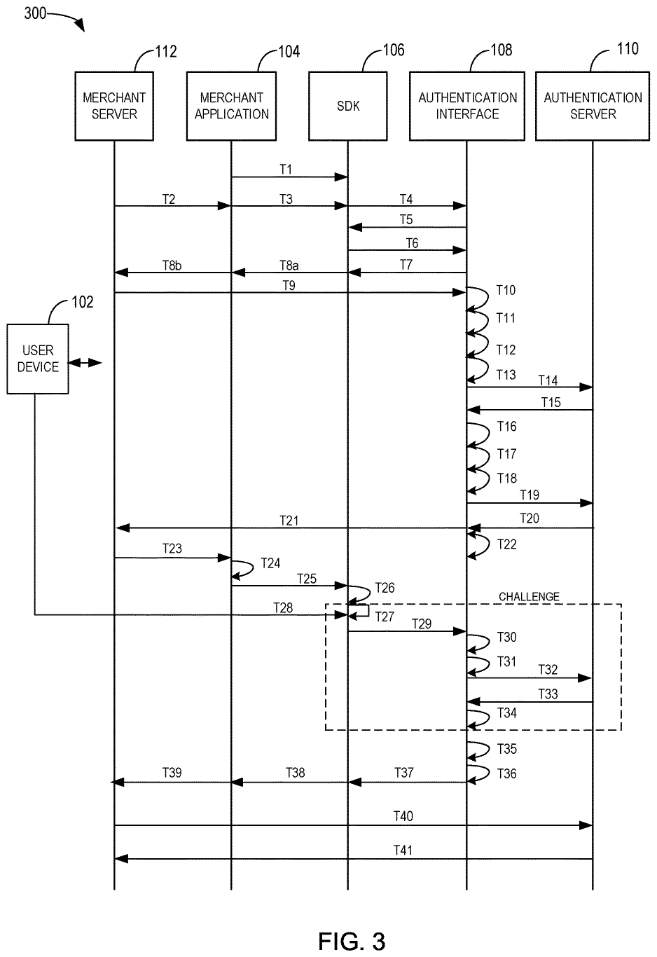

FIG. 3 shows a process 300 for processing payment transactions using an authentication and/or challenge protocol, according to some non-limiting embodiments or aspects. At a step T1, the merchant application 104 may be configured based on an SDK to generate the SDK 106 (a merchant application compiled using an SDK). At a step T2, the merchant server 112 may transmit a web token (e.g., JSON web token) to the merchant application 104. At a step T3, the merchant application 104 may initiate an electronic payment transaction and communicate the web token and callback to the SDK 106. At a step T4, the SDK 106 may communicate with the authentication interface 108 to request an authentication web token, and at a step T5, the authentication interface 108 may transmit an authentication web token to the SDK 106.

At a step T6, the SDK 106 may retrieve device data (e.g., browser data) from the user device 102 initiating the transaction and communicate the device data to the authentication interface 108 for storage by the authentication interface 108 and/or the authentication server 110. At a step T7, the authentication interface may return a status code to the SDK 106 indicating receipt and storage of the device data. At a step T8a, the SDK 106 may validate the transaction and send a message to the merchant application 104, and at a step T8b, the merchant application 104 may pass the message to the merchant server 112.

With continued reference to FIG. 3, at a step T9, the merchant server 112 may generate and communicate a lookup request to the authentication interface 108. At steps T10-T11, the authentication interface 108 may retrieve the device data from its database. At a step T12, the authentication interface 108 may encrypt the device data with a first public key to generate first encrypted data. At a step T13, the authentication interface 108 may generate an authentication request containing the first encrypted data. At a step T14 the authentication request may be transmitted to the authentication server 110. At a step T15, the authentication server 110 may generate an authentication decision by decrypting the first encrypted data (e.g., with a first private key associated with the authentication server 110 and forming a first key pair with the first public key). The authentication decision may be to authenticate or not authenticate the transaction. The authentication server 110 may generate an authentication response containing the authentication decision and transmit the authentication response to the authentication interface 108.

At a step T16, the authentication interface 108 may determine whether the authentication decision was to validate or not validate the transaction based on the received authentication response. At a step T17, the authentication interface 108 may verify that the content of the authentication response is valid, such as based on a digital signature contained in the authentication response. At a step T18, the authentication interface 108 may generate an encryption key to be used in the first challenge. At a step T19, authentication interface 108 may generate and communicate a first challenge request to the authentication server 110. The authentication interface 108 may encrypt first challenge data using the encryption key (e.g. a public key), which encrypted data may be contained in the first challenge request. At a step T20, the authentication server 110 may decrypt the encrypted data in the first challenge request using a private key forming a key pair with the public key. The authentication server 110 may generate a first challenge decision based on whether the decrypted data matches an expected value. The authentication server 110 may generate a first challenge response containing the first challenge decision and transmit the first challenge response to the authentication interface 108. The first challenge response may be encrypted.

With continued reference to FIG. 3, at a step T21 the authentication interface 108 may generate and transmit a lookup response to the merchant server 112. At a step T22, the authentication interface 108 may decrypt the first challenge response.

At a step T23, the merchant server 112 may generate and transmit a purchase response to the merchant application 104, which may be verified thereby at step T24. At a step T25, merchant application 104 may initiate a message to continue processing of the transaction, which may contain data, such as a transaction identifier, a payload, or a callback. At step T26, SDK 106 may validate the message.

With continued reference to FIG. 3, at a step T27, SDK 106 may cause user interface to display a challenge screen on the user interface of the user device 102. At step T28, the user may input data to the user interface of the user device 102, which user input may be used during a second challenge protocol. At a step T29, the SDK 106 may generate and communicate a second challenge request to authentication interface 108. At a step T30, in response to receiving the second challenge request, the authentication interface 108 may initiate processing of the second challenge. At a step T31, the authentication interface 108 may retrieve the encryption key and encrypt the challenge data (e.g., data input to the user device 102).

At a step T32, the authentication interface 108 may generate a second challenge request containing the encrypted data and transmit the second challenge request to the authentication server 110. At a step T33, the authentication server 110 may decrypt the encrypted data in the second challenge request using a private key forming a key pair with the public key. The authentication server 110 may generate a second challenge decision based on whether the decrypted data matches an expected value. The authentication server 110 may generate a second challenge response containing the second challenge decision and transmit the second challenge response to the authentication interface 108. The second challenge response may be encrypted. At a step T34, the authentication interface 108 may decrypt the second challenge response.

At a step T35, the authentication interface 108 may determine whether to authenticate the transaction based on the second challenge response. The authentication interface 108 may generate an authentication response containing the determination of whether to authenticate the transaction at step T36, which may be transmitted to the SDK 106 at T37.

With continued reference to FIG. 3, at a steps T38-T39, the authentication response may be transmitted to the merchant application 104 and the merchant server 112, respectively. At a step T40, the merchant server 112 may generate and communicate an authorization request to the authentication server 110 (e.g., of an issuer system), and the authorization request may comprise an electronic commerce indicator (ECI) code and/or a CAVV result code indicating whether the transaction was authenticated or not authenticated. At a step T41, the authentication server 110 may generate an authorization decision based at least in part on the ECI code and/or CAVV result code. The authorization decision may be to authorize or decline the payment transaction. The authentication server 110 may generate an authorization response containing the authorization decision, which may be transmitted to the merchant server 112 to terminate the transaction (if the authorization decision is to decline) or to further process the transaction (if the authorization decision is to authorize).

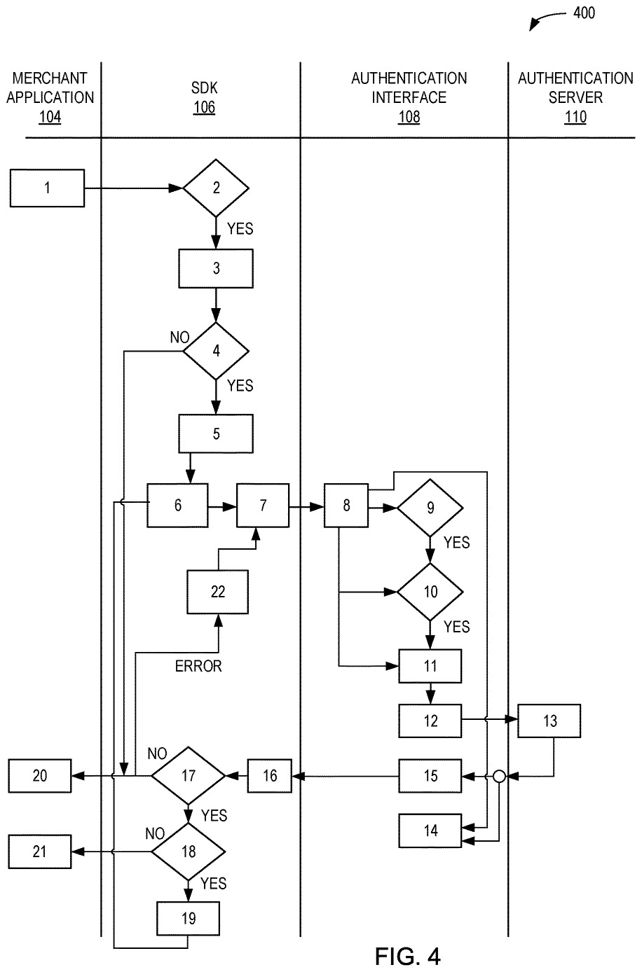

FIG. 4 shows a process 400 for processing payment transactions using a challenge protocol, according to some non-limiting embodiments or aspects. The previously described authentication protocol may have already been executed and failed, such that the challenge protocol is invoked. At a Step 1, the merchant application may initiate a challenge protocol by generating and communicating a challenge message to the SDK 106. The challenge message may contain a payload comprising transaction data to be used during the challenge protocol.

At a Step 2, the SDK 106 may validate the payload. At a Step 3, the SDK 106 may retrieve a root certificate (e.g., previously described third key associated with the authentication server 110). At Step 4, the SDK 106 may validate the encrypted data (e.g., digital certificate) from the authentication server 110 using the root certificate. If the digital certificate is invalid, the process may proceed to Step 20. If the If the digital certificate is valid, the process may proceed to Step 5. At Step 5, the SDK 106 may retrieve the second keys (e.g. from the Diffie-Hellman key exchange previously described) to be used in the challenge protocol. The key retrieved may be the second public key for the authentication server 110.

At a Step 6, the SDK 106 may encrypt the challenge data (e.g., transaction data) by applying the second public key for the authentication server 110 to the challenge data to generate second encrypted data. At a Step 7, the SDK 106 may generate the challenge request comprising the second encrypted data and any other relevant metadata. The SDK 106 may transmit the challenge request to the authentication interface 108.

At a Step 8, the authentication interface 108 may determine a payload contained in the challenge request, an issuer system and/or transaction service provider for the transaction, the metadata, a web token, and/or a transaction identifier contained therein. At a Step 9, the authentication interface 108 may validate the challenge request based on the web token. At a Step 10, the authentication interface 108 may validate the challenge request based on determining that the digital signature is valid. At a Step 11 in response to validating a digital signature from the authentication server 110, the authentication interface 108 may determine the authentication server 110 based on, for example, the determined issuer system and/or transaction service provider. Based on the determined authentication server 110, the authentication interface may retrieve a web address (e.g., uniform resource locator (URL)) for communicating with the corresponding authentication server 110. At a Step 12, the authentication interface 108 may transmit the challenge request to the authentication server 110 using the URL.

With continued reference to FIG. 4, at a Step 13, the authentication server 110 may generate a challenge decision based on the challenge request. This may include the authentication server 110 applying the second private key to the second encrypted data to determine if the decrypted transaction data (e.g., the decrypted second data) matches the correct transaction data for the payment transaction. In response to the decrypted second data matching an expected result, the challenge decision may be to validate the transaction. In response to the decrypted second data not matching the expected result, the challenge decision may be to not validate the transaction. The authentication server 110 may generate a challenge response containing the challenge decision and transmit the challenge response to the authentication interface 108.

At a Step 14, the challenge request and response contents and/or metadata may be stored in a data log (e.g., an Active MQ data log). At a Step 15, in response to receiving the challenge response, the authentication interface 108 may transmit the challenge response to the SDK 106. At a Step 16, the SDK 106 may receive the challenge response.

At a Step 17, the SDK 106 may validate the challenge response. If the challenge response is not validated, the process may proceed to Step 20, which may return an error message to the merchant application 104. If the challenge response is validated, the process may proceed to Step 18.

At Step 18, the SDK 106 may determine whether a challenge screen is to be displayed. If not, the process may proceed to Step 21 to return a result of the challenge. If a challenge screen is to be displayed, the SDK 106 may generate a challenge screen to be displayed on the user's device. At a Step 19, the SDK 106 may receive user input to the displayed challenge screen, and the user input may be transmitted to Step 6 to continue the challenge process. At the Step 6, the user input may be encrypted for the challenge process.

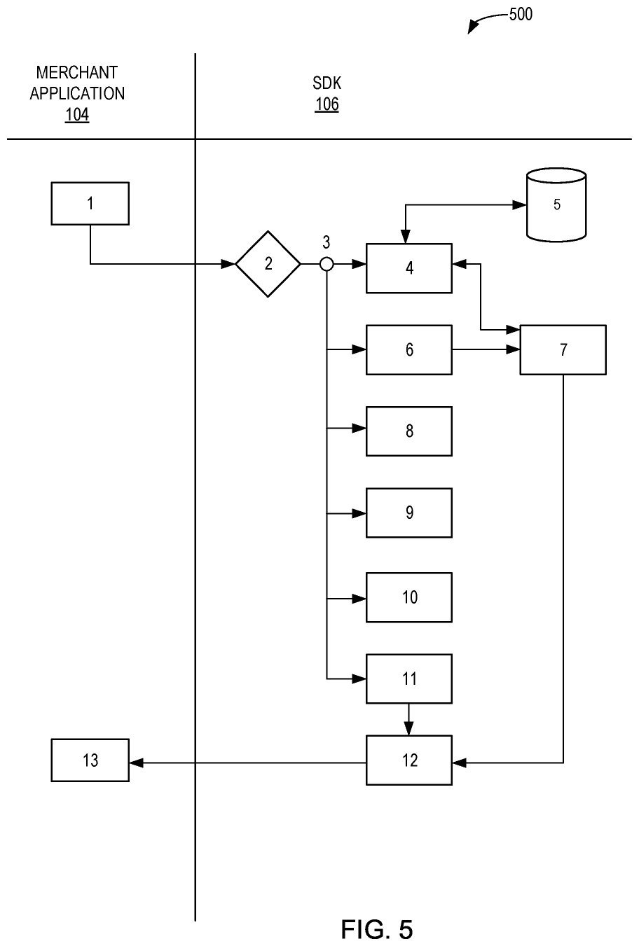

FIG. 5 shows a process 500 for encrypting device data during an authentication protocol, according to some non-limiting embodiments or aspects. In response to initiation of a payment transaction between a merchant and a user, at Step 1, the merchant application 104 may generate and transmit a request to the SDK 106 (e.g., a merchant application compiled using an SDK) to cause the SDK 106 to request a key value for the authentication protocol. At a Step 2, in response to receiving the request, the SDK 106 may validate the payment device, such as validate an issuer system and/or a transaction processing system of the payment device. At a Step 3, if the issuer system and/or a transaction processing system of the payment device are not valid, an invalid input exception may be returned to the merchant application 104. Otherwise, the process continues to Step 4. At Step 4, the SDK 106 may retrieve the public key associated with the issuer system and/or a transaction processing system of the payment device, such as by retrieving the stored public key in the database in Step 5. At a Step 6, the SDK 106 may collect device data associated with the user device (e.g., a computing device) initiating the payment transaction.

With continued reference to FIG. 5, at a Step 7, the SDK 106 may encrypt the device data from Step 6 using the public key retrieved in Step 4 to generate first encrypted data. At a Step 8, the SDK 106 may collect, generate, and/or retrieve a transaction identifier, an SDK application number, an SDK reference number, and/or the like. At a Step 9, the SDK 106 may generate an ephemeral key pair, which may be a key pair used for the instant payment transaction, such as during a challenge protocol. At a Step 10, the SDK 106 may collect, generate, and/or retrieve any other data needed to process the transaction, such as during the authentication and/or challenge protocols.

At a Step 11, the SDK may retrieve the public key associated with the authentication interface 108. At a Step 12, based on the public key associated with the authentication interface 108 and the encrypted device data, a further security layer may be applied, such as using a burrito exchange protocol. At a Step 13, the encrypted string to be used during the authentication protocol is generated.

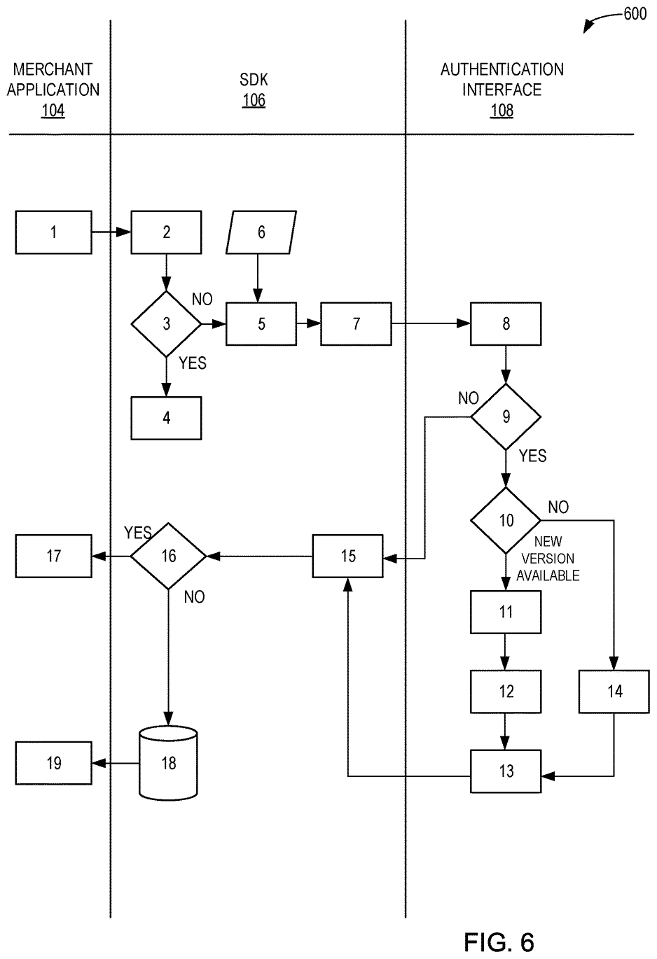

FIG. 6 shows a process 600 for updating encryption keys, according to some non-limiting embodiments or aspects. At a Step 1, the merchant application 104 may initialize a request to update the cached keys (e.g., the non-ephemeral keys of the authentication server 110). The request may comprise a web token (e.g., a JSON web token). At a Step 2, the SDK 106 may receive the initialization message and initiate the process to update the keys. At a Step 3, the SDK 106 may determine whether any public keys are cached (e.g., stored in cache memory and not hardcoded into SDK code). At a Step 4, if public keys are cached, the SDK 106 may retrieve the version of the cached keys. The version of the cached keys may be transmitted to Step 5. At a Step 5, the SDK 106 may collect the merchant web token from Step 6 along with a key version (if applicable) and generate a request for an updated key based thereon. At a Step 7, the SDK 106 may transmit the request for the updated key to the authentication interface 108. The request may contain the web token, the transaction identifier generated by the SDK 106, the key version, and the like.

With continued reference to FIG. 6, at a Step 8, the authentication interface 108 may validate the values received in the request from the SDK 106. At a step 9, the authentication interface 108 may validate the web token. If the web token is invalid, the process moves to Step 15. If the web token is valid, the process moves to Step 10. At a Step 10, the authentication interface 108 may check the key version and determine if a new key version is available. If no new key version is available, the authentication interface may generate a return value that no key version is available at Step 14. If a new key version is available, at Step 11, the authentication interface 108 may retrieve the most recent version of the key(s). The authentication interface 108 may also generate a token (e.g., a JSON web token). At a Step 12, the authentication interface 108 may generate a message containing the updated keys and the web token. At Step 12, the authentication interface 108 may generate a return value that a new key version is available.

At a Step 13, the authentication interface 108 may generate a response message containing whether updated keys are available, the updated keys, if available, and optionally the web token, and the SDK 106 may be received in the response message at Step 15. At Step 16, the SDK 106 may determine whether there is an error in the response message, such as based on the web token being valid or invalid. If there is an error, the process proceeds to Step 17 where an error message is returned to the merchant application 104. If there is no error, the process proceeds to Step 18, where the updated keys are stored (e.g., cached). At a Step 19, in response to caching the updated keys, a success message may be returned to the merchant application 104.

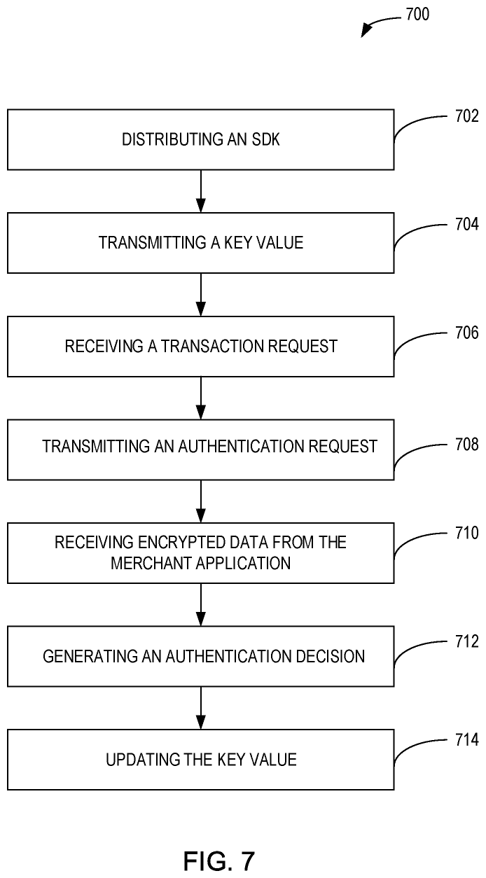

Referring now to FIG. 7, shown is a flow diagram for a process 700 for updating encryption keys, according to some non-limiting embodiments or aspects. The steps shown in FIG. 7 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of process 700 may be performed (e.g., completely, partially, and/or the like) by authentication interface 108 (e.g., one or more devices of authentication interface 108). In some non-limiting embodiments or aspects, one or more of the steps of process 700 may be performed (e.g., completely, partially, and/or the like) by another system, another device, another group of systems, or another group of devices, separate from or including user device 102, merchant application 104, SDK 106, and/or authentication server 110.

As shown in FIG. 7, at step 702, process 700 may include distributing SDK 106, which may include at least one software function to establish a secure connection between a client-side application compiled with the SDK 106 and a remote server computer. For example, the authentication interface 108 may distribute SDK 106 to merchant application 104 to enable merchant application 104 compiled based on SDK 106 to establish a secure connection with a remote server computer, such as authentication interface 108 and/or authentication server 110.

As shown in FIG. 7, at step 704, process 700 may include, in response to receiving a request from merchant application 104 incorporating SDK 106, authentication interface 108 may transmit at least one key value to merchant application 104. Merchant application 104 may cache the at least one key value.

As shown in FIG. 7, at step 706, process 700 may include receiving a transaction request associated with a transaction, the transaction request initiated through merchant application 104. For example, authentication interface 108 may receive the transaction request from merchant application 104.

In some non-limiting embodiments or aspects, the transaction request may be associated with a payment transaction between a user associated with user device 102 and a merchant associated with merchant application 104, the payment transaction initiated with the user device 102 of the user.

In some non-limiting embodiments or aspects, merchant application 104 may collect device data associated with the user device 102. The device data may be encrypted during the authentication process to generate an authentication decision for the transaction in some examples. Device data may comprise any data associated with the user device 102 that may either uniquely identify the user device 102 or contribute to identifying at least one characteristic of the user device 102. Non-limiting examples of device data may include a unique device identifier, a device type, a network address (e.g., IP address), device geolocation data, device browser data, and the like. Non-limiting examples of device browser data may include a browser accept header, data indicating whether the browser is Java-enabled, browser language (e.g., language in which browser displays the data to the user via the user interface), browser color depth (e.g., bit depth of the color palette for displaying images), browser screen depth (e.g., bit depth of the screen), browser screen height, browser screen width, browser time zone (e.g., time zone associated with the browser), browser user agent (e.g., the software agent acting on behalf of the user), or other data associated with the browser of the mobile device.

As shown in FIG. 7, at step 708, process 700 may include transmitting an authentication request to merchant application 104 in response to receiving the transaction request. For example, authentication interface 108 may transmit the authentication request to merchant application 104.

As shown in FIG. 7, at step 710, process 700 may include receiving encrypted data from merchant application 104, the encrypted data generated with the at least one key value and based on device data associated with the user device 102 initiating the transaction. For example, authentication interface 108 and/or authentication server 110 may receive the encrypted data from merchant application 104.

In some non-limiting embodiments or aspects, the authentication decision represents that the encrypted data is not valid, and the process 700 may further include initiating a challenge protocol in response to determining that the encrypted data is not valid. The challenge protocol may include transmitting a public key generated by the authentication server 110 to the merchant application 104, the authentication server 110 retaining a private key, the public key and the private key forming a key pair. The challenge protocol may include receiving encrypted data from the merchant application generated with the public key and based on challenge data. The challenge request may be transmitted to the authentication server 110, the challenge request comprising the second encrypted data. A challenge response may be received from the authentication server 110, the challenge response validating the second encrypted data based on decrypting the second encrypted data by applying the private key to the second encrypted data.

As shown in FIG. 7, at step 712, process 700 may include generating an authentication decision for the transaction based on determining whether the encrypted data is valid. For example, authentication interface 108 and/or authentication server 110 may generate the authentication decision. Authentication interface 108 may communicate with authentication server 110 to generate the authentication decision.

In some non-limiting embodiments or aspects, generating the authentication decision may include: in response to receiving the encrypted data from merchant application 104, determining (e.g., by the authentication interface 108) the authentication server 110 associated with the transaction request from among a plurality of authentication servers 110; generating (e.g., by authentication interface 108) a request comprising the encrypted data, and, based on the determined authentication server 110, transmitting (e.g., by authentication interface 108) the request to the authentication server 110 to cause the authentication server 110 to determine whether the encrypted data is valid.

As shown in FIG. 7, at step 714, process 700 may include updating, via the secure connection and in merchant application 104, the at least one key value to replace the at least one key value with at least one updated key value. For example, authentication interface 108 may update the at least one key value with the at least one updated key value in merchant application 104 by communicating the updated key value thereto.

In some non-limiting embodiments or aspects, updating the at least one key value may include transmitting the at least one updated key value to merchant application 104 to cause the at least one updated key value to be cached in merchant application 104.

In some non-limiting embodiments or aspects, the at least one key value may be updated in response to receiving the transaction request.

In some non-limiting embodiments or aspects, the at least one key value and the at least one updated key value may not be incorporated (e.g., hardcoded) into SDK 106.

In some non-limiting embodiments or aspects, updating the at least one key value does not comprise modifying code of SDK 106.

FIG. 8 shows an electronic payment processing network 800 according to non-limiting embodiments or aspects. The payment processing network may be used in conjunction with the systems and methods described herein. It will be appreciated that the particular arrangement of electronic payment processing network 800 shown is for example purposes only, and that various arrangements are possible. Transaction processing system 801 (e.g., a transaction handler) is shown to be in communication with one or more issuer systems (e.g., such as issuer system 806) and one or more acquirer systems (e.g., such as acquirer system 808). Although only a single issuer system 806 and single acquirer system 808 are shown, it will be appreciated that transaction processing system 801 may be in communication with a plurality of issuer systems and/or acquirer systems. In some embodiments, transaction processing system 801 may also operate as an issuer system such that both transaction processing system 801 and issuer system 806 are a single system and/or controlled by a single entity.

In some non-limiting embodiments or aspects, transaction processing system 801 may communicate with merchant system 804 directly through a public or private network connection. Additionally or alternatively, transaction processing system 801 may communicate with merchant system 804 through payment gateway 802 and/or acquirer system 808. In some non-limiting embodiments or aspects, an acquirer system 808 associated with merchant system 804 may operate as payment gateway 802 to facilitate the communication of transaction requests from merchant system 804 to transaction processing system 801. Merchant system 804 may communicate with payment gateway 802 through a public or private network connection. For example, a merchant system 804 that includes a physical POS device may communicate with payment gateway 802 through a public or private network to conduct card-present transactions. As another example, a merchant system 804 that includes a server (e.g., a web server) may communicate with payment gateway 802 through a public or private network, such as a public internet connection, to conduct card-not-present transactions.

In some non-limiting embodiments or aspects, transaction processing system 801, after receiving a transaction request from merchant system 804 that identifies an account identifier of a payor (e.g., such as an account holder) associated with an issued payment device 810 (also referred to as “consumer device 810”), may generate an authorization request message to be communicated to the issuer system 806 that issued the payment device 810 and/or account identifier. Issuer system 806 may then approve or decline the authorization request and, based on the approval or denial, generate an authorization response message that is communicated to transaction processing system 801. Transaction processing system 801 may communicate an approval or denial to merchant system 804. When issuer system 806 approves the authorization request message, it may then clear and settle the payment transaction between the issuer system 806 and acquirer system 808.

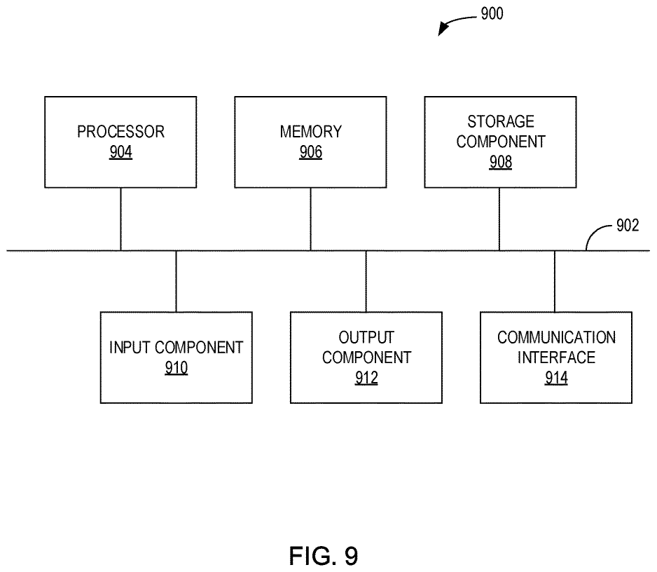

Referring now to FIG. 9, shown is a diagram of example components of a device 900 according to non-limiting embodiments or aspects. Device 900 may correspond to at least one of user device 102, merchant application 104, SDK 106, authentication interface 108, authentication server 110, and/or merchant server 112 in FIG. 1-6 and/or at least one of transaction processing system 801, payment gateway 802, merchant system 804, issuer system 806, acquirer system 808, and/or consumer device 810 in FIG. 8, as an example. In some non-limiting embodiments or aspects, such systems or devices in FIGS. 1-6 and 8 may include at least one device 900 and/or at least one component of device 900. The number and arrangement of components shown in FIG. 9 are provided as an example. In some non-limiting embodiments or aspects, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

As shown in FIG. 9, device 900 may include bus 902, processor 904, memory 906, storage component 908, input component 910, output component 912, and communication interface 914. Bus 902 may include a component that permits communication among the components of device 900. In some non-limiting embodiments or aspects, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 9, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

In some non-limiting embodiment or aspects, a computer program product for updating encryption keys includes at least one non-transitory computer readable medium including program instructions that, when executed by at least one processor, cause the at least one processor to execute one of the previously-described methods. The at least one processor may include any of the components shown in FIGS. 1-6 and 8 (e.g., user device 102, merchant application 104, SDK 106, authentication interface 108, authentication server 110, merchant server 112, transaction processing system 801, payment gateway 802, merchant system 804, issuer system 806, acquirer system 808, consumer device 810, and the like).

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method comprising:
distributing a software development kit (SDK) including at least one software function to establish a secure connection between a client-side application running the SDK and a remote server computer;
in response to receiving a request from a merchant application incorporating the SDK, transmitting, to the merchant application, at least one key value;
receiving a transaction request associated with a transaction, the transaction request initiated through the merchant application;
in response to receiving the transaction request, transmitting an authentication request to the merchant application;
receiving encrypted data from the merchant application, the encrypted data generated with the at least one key value and based on device data associated with a user device initiating the transaction;
generating an authentication decision for the transaction based on determining whether the encrypted data is valid; and
updating, via the secure connection and in the merchant application, the at least one key value to replace the at least one key value with at least one updated key value.

2. The computer-implemented method of claim 1, wherein the transaction request is associated with a payment transaction between a user associated with the user device and a merchant associated with the merchant application, the user device being a mobile device of the user.

3. The computer-implemented method of claim 1, wherein determining whether the encrypted data is valid comprises decrypting the encrypted data by applying at least one second key value and determining whether the decrypted data is valid, the at least one second key value and the at least one first key value forming a key pair.

4. The computer-implemented method of claim 1, wherein the authentication decision represents that the encrypted data is not valid, the computer-implemented method further comprising initiating a challenge protocol in response to determining that the encrypted data is not valid, the challenge protocol comprising:
transmitting a public key generated by an authentication server to the merchant application, the authentication server retaining a private key, the public key and the private key forming a key pair;
receiving second encrypted data from the merchant application generated with the public key and based on challenge data;
transmitting a challenge request to the authentication server, the challenge request comprising the second encrypted data; and
receiving a challenge response from the authentication server, the challenge response validating the second encrypted data based on decrypting the second encrypted data by applying the private key to the second encrypted data.

5. The computer-implemented method of claim 1, wherein updating the at least one key value comprises transmitting via the secure connection the at least one updated key value to the merchant application to cause the at least one updated key value to be cached in the merchant application.

6. The computer-implemented method of claim 1, wherein generating the authentication decision comprises:
in response to receiving the encrypted data from the merchant application, determining an authentication server associated with the transaction request;
generating a request comprising the encrypted data, and
based on the determined authentication server, transmitting the request to the authentication server to cause the authentication server to determine whether the encrypted data is valid.

7. The computer-implemented method of claim 1, wherein the at least one key value is updated in response to receiving the transaction request.

8. The computer-implemented method of claim 1, wherein the at least one key value and the at least one updated key value are not hardcoded into the SDK.

9. The computer-implemented method of claim 1, wherein updating the at least one key value does not comprise modifying code of the SDK.

10. A system comprising at least one processor configured to:
distribute a software development kit (SDK) including at least one software function to establish a secure connection between a client-side application running the SDK and a remote server computer;
in response to receiving a request from a merchant application incorporating the SDK, transmit, to the merchant application, at least one key value;
receive a transaction request associated with a transaction, the transaction request initiated through the merchant application;
in response to receiving the transaction request, transmit an authentication request to the merchant application;
receive encrypted data from the merchant application, the encrypted data generated with the at least one key value and based on device data associated with a user device initiating the transaction;
generate an authentication decision for the transaction based on determining that the encrypted data is valid; and
update, via the secure connection and in the merchant application, the at least one key value to replace the at least one key value with at least one updated key value.

11. The system of claim 10, wherein the transaction request is associated with a payment transaction between a user associated with the user device and a merchant associated with the merchant application, the user device being a mobile device of the user.

12. The system of claim 10, wherein determining whether the encrypted data is valid comprises decrypting the encrypted data by applying at least one second key value and determining whether the decrypted data is valid, the at least one second key value and the at least one first key value forming a key pair.

13. The system of claim 10, wherein the authentication decision represents that the encrypted data is not valid, the at least one processor configured to initiate a challenge protocol in response to determining that the encrypted data is not valid, the challenge protocol comprising:
transmitting a public key generated by an authentication server to the merchant application, the authentication server retaining a private key, the public key and the private key forming a key pair;
receiving second encrypted data from the merchant application generated with the public key and based on challenge data;
transmitting a challenge request to the authentication server, the challenge request comprising the second encrypted data; and
receiving a challenge response from the authentication server, the challenge response validating the second encrypted data based on decrypting the second encrypted data by applying the private key to the second encrypted data.

14. The system of claim 10, wherein updating the at least one key value comprises transmitting via the secure connection the at least one updated key value to the merchant application to cause the at least one updated key value to be cached in the merchant application.

15. The system of claim 10, wherein generating the authentication decision comprises:
in response to receiving the encrypted data from the merchant application, determining an authentication server associated with the transaction request;
generating a request comprising the encrypted data, and
based on the determined authentication server, transmitting the request to the authentication server to cause the authentication server to determine whether the encrypted data is valid.

16. The system of claim 10, wherein the at least one key value is updated in response to receiving the transaction request.

17. The system of claim 10, wherein the at least one key value and the at least one updated key value are not hardcoded into the SDK.

18. The system of claim 10, wherein updating the at least one key value does not comprise modifying code of the SDK.

19. A computer program product comprising at least one non-transitory computer-readable medium including program instructions that, when executed by at least one processor, cause the at least one processor to:
distribute a software development kit (SDK) including at least one software function to establish a secure connection between a client-side application running the SDK and a remote server computer;
in response to receiving a request from a merchant application incorporating the SDK, transmit, to the merchant application, at least one key value;
receive a transaction request associated with a transaction, the transaction request initiated through the merchant application;
in response to receiving the transaction request, transmit an authentication request to the merchant application;
receive encrypted data from the merchant application, the encrypted data generated with the at least one key value and based on device data associated with a user device initiating the transaction;
generate an authentication decision for the transaction based on determining whether the encrypted data is valid; and
update, via the secure connection and in the merchant application, the at least one key value to replace the at least one key value with at least one updated key value.

20. The computer program product of claim 19, wherein the transaction request is associated with a payment transaction between a user associated with the user device and a merchant associated with the merchant application, the user device being a mobile device of the user.

21. The computer program product of claim 19, wherein determining whether the encrypted data is valid comprises decrypting the encrypted data by applying at least one second key value and determining whether the decrypted data is valid, the at least one second key value and the at least one first key value forming a key pair.

22. The computer program product of claim 19, wherein the authentication decision represents that the encrypted data is not valid, the program instructions cause initiating a challenge protocol in response to determining that the encrypted data is not valid, the challenge protocol comprising:
transmitting a public key generated by an authentication server to the merchant application, the authentication server retaining a private key, the public key and the private key forming a key pair;
receiving second encrypted data from the merchant application generated with the public key and based on challenge data;
transmitting a challenge request to the authentication server, the challenge request comprising the second encrypted data; and
receiving a challenge response from the authentication server, the challenge response validating the second encrypted data based on decrypting the second encrypted data by applying the private key to the second encrypted data.

23. The computer program product of claim 19, wherein updating the at least one key value comprises transmitting via the secure connection the at least one updated key value to the merchant application to cause the at least one updated key value to be cached in the merchant application.

24. The computer program product of claim 19, wherein generating the authentication decision comprises:
in response to receiving the encrypted data from the merchant application, determining an authentication server associated with the transaction request;
generating a request comprising the encrypted data, and
based on the determined authentication server, transmitting the request to the authentication server to cause the authentication server to determine whether the encrypted data is valid.

25. The computer program product of claim 19, wherein the at least one key value is updated in response to receiving the transaction request.

26. The computer program product of claim 19, wherein the at least one key value and the at least one updated key value are not hardcoded into the SDK.

27. The computer program product of claim 19, wherein updating the at least one key value does not comprise modifying code of the SDK.
